(19) United States
(12) Patent Application Publication
(10) Pub. No.: US 2022/0391868 A1
(43) Pub. Date: Dec. 8, 2022

(54) CROPLAND COIN CRYPTOCURRENCY NON-FUNGIBLE TOKEN (NFT) SYSTEM AND METHOD

(71) Applicant: Agland Capital, LLC, Sheridan, WY (US)

(72) Inventors: Matthew Jaeger, Minneola, KS (US); Andrew Hecht, Las Vegas, NV (US)

(21) Appl. No.: 17/833,500

(22) Filed: Jun. 6, 2022

Related U.S. Application Data
(60) Provisional application No. 63/197,183, filed on Jun. 4, 2021.

(51) Int. Cl. G06Q 20/12; G06Q 20/06

(52) U.S. Cl. CPC G06Q 20/1235; G06Q 20/065; G06Q 2220/165

(57) ABSTRACT

A cropland coin cryptocurrency system assigns non-fungible tokens (NFTs) to cropland. The NFTs can be utilized in various transactions, including buying and selling, borrowing and lending and exchange transactions.

### CROSS-REFERENCE TO RELATED APPLICATION

This application claims priority in U.S. Provisional Patent Application No. 63/197,183, filed Jun. 4, 2021, which is incorporated herein by reference.

### BACKGROUND OF THE INVENTION

### 1.Field of the Invention

The present invention relates generally to representing cropland with cryptocurrency, i.e., digital coins or non-fungible tokens (NFTs). NFT transaction systems and methods involving agricultural real estate are disclosed.

### 2. Description of the Related Art

Cropland, including farms and ranches, is generally a revenue-producing asset. Revenue is derived from crops and livestock, which can be monetized when harvested and sold for producing food. Crop and livestock transactions can also be monetized in futures markets. Futures markets enable cropland owners, including farmers and ranchers, to optimize profitability of their enterprises. The general objective of farming and livestock operations is maximizing return-on-investment (ROI), through revenue-generating operations and real estate value appreciation.

Although most cropland has appreciated in value, and is expected to continue appreciating, there are disadvantages. For example, cropland is expensive to own, with burdens of relatively high property taxes, maintenance and management. Moreover, expanding cropland holdings can be challenging due to the relative infrequency of specific cropland parcels being offered for sale. For example, farms and ranches often stay within families for generations. Still further, croplands are relatively illiquid and may require months or even years before they can be liquidated. The pool of prospective purchasers for such assets tends to be relatively small. Prevailing interest rates, commodity prices and prevailing economic conditions (locally, nationally and globally) are additional factors, which can impact cropland liquidity.

Conventional cropland ownership generally obligates the owners for taxes, land care, maintenance, property management and managing farming and/or ranching enterprises. Such obligations and responsibilities can deter potential cropland purchasers and investors.

The present invention addresses these concerns with cropland ownership and investing by applying cryptocurrency transactional procedures. Cropland has historically been a significant wealth-creation asset. Moreover, cropland generally yields a return on investment (ROI) represented by crops and livestock, which can be marketed. Moreover, productive cropland tends to appreciate in value over time.

In practicing the present invention, a proprietary formula can be utilized for determining average values of cropland. The formula can utilize information and records available from the U.S. Department of Agriculture (USDA) private company data, county records, corporate earnings reports and other sources. Cropland values and anticipated ROIs can be computed from such data, and updated as appropriate based on transactions.

A free and fair market price can be established for the NFTs pre-launch. The token prices can be slightly increased prelaunch, whereafter disclosure and release of tokens over time (e.g., years) can occur. Additional applications include NFTs corresponding to fertilizer, fuel, adjuvants, seed tokens and other crop inputs. The method enables maximizing profitability and return on investment (ROI).

Cropland control and ownership have conventionally been confined to relatively small groups of individuals and, more recently, cropland management and ownership corporations. The present invention facilitates individual investment and ownership via crypto currency, utilizing NFTs. Relatively secure computational resources are available for maintaining current ownership and revenue allocation records. Such records can be stored in and accessed from cloud-based servers and other computational resources.

The present invention accommodates NFT transactions in real time, with access available continuously. Transactions and owner ship information can be available and logged in a blockchain for security and verification purposes.

Heretofore there has not been available a system or method for utilizing NFTs for cropland transactions with the advantages and features of the present invention.

### SUMMARY OF THE INVENTION

In the practice of the present invention, cropland, generally represented in acreage, is assigned tokens comprising crop coins. An initial benchmark establishes ownership values. A digital currency exchange is utilized for transactions. Such transactions can include buying and selling, e.g., tokens, borrowing, lending and exchanges.

### BRIEF DESCRIPTION OF THE DRAWINGS

The drawings constitute a part of this specification and include exemplary embodiments of the present invention illustrating various objects and features thereof.

FIG. 1 is a schematic flow chart showing a cropland cryptocurrency system and method embodying aspects of the present invention.

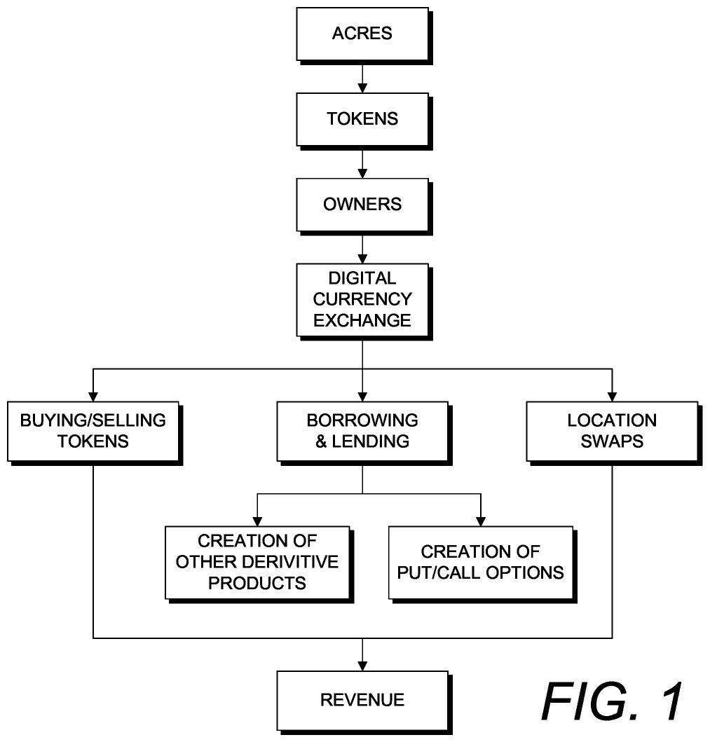

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. Said terminology will include the words specifically mentioned, derivatives thereof and words of similar meaning.

### II. Detailed Description of a Preferred Embodiment Cropland Coin System and Method

The Acres step involves assigning an addressable market consisting of a fixed number of tokens (i.e., crop coins) representing a number of acres worth a predetermined percentage for each acre. The Tokens step reflects current ownership, with the owners receiving tokens based on public ownership records. For example, and without limitation on the wide range of applications of the present invention, county governments typically include a register of deeds, which maintains a database consisting of ownership, property value assessments, tax, financing and transactional records.

At the Owners step, the initial market of token (i.e., crop coin) holders with tokens reflecting aggregate ownership value based on an initial benchmark is established. A Digital Currency Exchange step involves creating for transactions involving all NFTs, i.e., crop coin and derivatives.

The system progresses to one or more of the steps of:
a) Buying/selling tokens by transferring the economic value of the (crop coin) tokens for one party (the seller) to another party (the buyer).
b) Borrowing and lending, wherein a negotiated market for lending (crop coin) tokens from one party (the lender) to another party (the borrower) for a fixed term and a fee. The fee creates a forward curve or yield (lease values/token (crop coin) value for the term. The forward curve is annualized and is a function of the lease rates est. by market activity.

From the borrowing and lending step, the system and method can proceed to creation of other derivative products, including ETF and ETN products. Other derivatives can be created, including, without limitation: futures, futures, options, swaps, swot options, indices, tax collection and all other products from market innovations relating to NFT (crop coin) values. The borrowing and lending step can also lead to a step involving the creation of put/call options. These are a function of prices on the forward curve, location, swaps, or any other transactions based on the historical and implied volatility, and interest rated as calculated by market-accepted options pricing markets.
c) Location swaps can utilize premiums and/or discounts from benchmark NFT (crop coin) values for specific agricultural land locations negotiated by buyers and sellers or lenders and borrowers.

At a Revenue step, revenues accrue from fees on all exchange and over-the-counter transactions relating to the NFTs (i.e., crop coins).

It is to be understood that the invention can be embodied in various forms and is not to be limited to the examples specifically discussed above. The range of components and configurations which can be utilized in the practice of the present invention is virtually unlimited.

1. A non-fungible token (NFT) transaction method, which includes the steps of:
defining an addressable market with a fixed number of NFTs representing quantities of goods and an ownership percentage for each NFT;
allocating NFTs based on ownership;
establishing an initial benchmark of NFT value;
providing a digital currency exchange, including a platform for transactions involving NFTs and derivatives;
proceeding to one or more of the steps including: buying and selling NFTs; borrowing and lending NFTs; and providing location swaps using NFTs;
creating derivative products;
creating put/call options for NFTs; and
accruing revenue from fees on all exchanges and over-the-the-counter transactions relating to the NFTs.

2. The method according to claim 1, wherein said NFTs represent digital cropland.
